(19) United States
(12) Patent Application Publication
(10) Pub. No.: US 2024/0025026 A1
(43) Pub. Date: Jan. 25, 2024

(54) Machine Tool Apparatus, Machine Tool, and Method of Operating a Machine Tool

(71) Applicant: Robert Bosch GmbH, Stuttgart (DE)

(72) Inventors: Nico Schweer, Leinfelden-Echterdingen (DE); Florian Esenwein, Leinfelden-Echterdingen (DE)

(21) Appl. No.: 18/352,774

(22) Filed: Jul. 14, 2023

(30) Foreign Application Priority Data
Jul. 19, 2022 (DE) 10 2022 207 327.4
Jul. 3, 2023 (DE) 10 2023 206 273.9

(51) Int. Cl. B25F 5/00

(52) U.S. Cl. CPC B25F 5/008

(57) ABSTRACT

A machine tool apparatus includes at least one housing unit, which has a cooling air inlet section and a cooling air outlet section. The cooling air outlet section is arranged offset from the cooling air inlet section as viewed in the direction of a main extension axis of the housing unit. The machine tool apparatus further includes a connecting unit for fluidly connecting the cooling air inlet section with a fluid unit on the outside of the housing unit.

This application claims priority under 35 U.S.C. § 119 to application no. DE 10 2022 207 327.4, filed on Jul. 19, 2022 in Germany and to application no. DE 10 2023 206 273.9, filed on Jul. 3, 2023 in Germany, the disclosures of which are incorporated herein by reference in their entirety.

### BACKGROUND

A machine tool apparatus with at least one housing unit having a cooling air inlet section has already been proposed.

### SUMMARY

The disclosure starts from a machine tool apparatus with at least one housing unit which includes a cooling air inlet section.

It is proposed that the machine tool apparatus have a connection unit for fluidly connecting the cooling air inlet section to a fluid unit on the outside of the housing unit.

By designing the machine tool apparatus according to the disclosure, an air flow provided for the cooling air inlet section can advantageously also be used for the fluid unit. Advantageously, an air conducted via the fluid unit can be conditioned by means of the fluid unit before the cooling air inlet section. Advantageously, a particularly efficient and gentle cooling of an interior of the housing unit can be realized. By fluidically connecting the fluid unit with the cooling air inlet section, a coherent fluid flow channel can be realized, which can advantageously be used for several functions, for example for an extraction function to extract an ablation and for a cooling function to cool an interior of the housing unit. The principle is particularly suitable for brushless motors, especially for battery-powered devices.

In particular, the connection unit is provided for detachable fluid connection of the cooling air inlet section of the housing unit to the fluid unit on the outside of the housing unit. “Provided” is to be understood as meaning specifically configured, specifically designed and/or specifically equipped. When an object is provided for a particular function, this is to be understood as meaning that the object fulfills and/or performs that particular function in at least one application and/or operating state. By means of the connection unit, in particular, a dust-tight connection can be made between the housing unit and the fluid unit, preferably at least at the cooling air inlet section. In particular, the connecting unit is mechanically connected to the fluid unit in a state of being fluidly connected to the cooling air inlet section of the housing unit. The cooling air inlet section is preferably defined by one or more air inlet slots of the housing unit. The connection unit preferably has at least one connecting element for connecting, in particular, the cooling air inlet section to the fluid unit, preferably mechanically. The connecting element can be designed, for example, as a latching element, in particular as a latching recess or as a latching projection, as a Velcro element, for example as a Velcro strip or the like, as a bayonet fastening element, as a clamping element, as a screw element, as a magnetic element or as any other connecting element that appears to be useful to a person skilled in the art.

The machine tool apparatus is preferably provided for use on a machine tool, in particular on a machine tool housing of the machine tool. It is conceivable that the machine tool apparatus can be at least partially detachably fastened to the machine tool, in particular to the machine tool housing. Alternatively, it is also conceivable that the machine tool apparatus, preferably at least the housing unit, is at least partially integrally designed with at least part of the machine tool housing. By the fact that “at least one unit and at least one further unit or object are at least partially designed integrally with one another”, it is to be understood in particular that at least one element of the unit is designed integrally with at least one further element of the further unit or with the object. “Integrally” can be understood as meaning connected at least by substance-to-substance bonding, for example by a welding process, an adhesive bonding process, a process of molding on and/or another process that appears to be useful to the person skilled in the art, and/or advantageously formed in one piece, for example by production from a casting and/or by production in a single- or multi-component injection molding method and advantageously from a single blank. For example, the housing unit is at least partially part of the machine tool housing.

Preferably, the at least one connecting element is designed integrally with at least a part of the housing unit. Alternatively, it is also conceivable for the at least one connecting element to be designed separately from the housing unit, in particular to be detachably, preferably non-destructively detachably, fastened to the housing unit. The fluid unit preferably has at least one fluid channel. The fluid unit is preferably provided for use in extracting an ablation that can be generated during machining of a workpiece, preferably by means of a tool that can be arranged on the machine tool. It is conceivable that the fluid unit comprises a filter element, in particular a dust collection element, a dust collection container or the like, or a combination thereof.

The housing unit has at least one cooling air outlet section. The cooling air outlet section is arranged offset from the cooling air inlet section, as viewed in the direction of a main extension axis of the housing unit. By a “main extension axis” of an object can be understood in particular an axis which runs parallel to a longest edge of a smallest geometrical cuboid which just completely encloses the object, and in particular runs through the center of the cuboid. The cooling air outlet section is preferably defined by one or more air inlet slots of the housing unit. Preferably, the cooling air inlet section is spaced apart from the cooling air inlet section as viewed in the direction of the main extension axis of the housing unit. Preferably, an airflow guided from the cooling air inlet section to the cooling air outlet section of the housing unit runs at least in sections at least substantially parallel to the main extension axis of the housing unit. The term “substantially (in) parallel” should in particular in this context be understood to mean an orientation of a direction relative to a reference direction, in particular in a plane, wherein the direction has a deviation from the reference direction of in particular less than 8°, advantageously less than 5°, and particularly advantageously less than 2°.

It is further proposed that the connection unit have at least one fluid channel element for fluid connection of the cooling air inlet section to the fluid unit, which can be detachably fastened to the outside of the housing unit, preferably detachable in a non-destructive manner. Alternatively, it is conceivable that the at least one fluid channel element is designed integrally with at least a part of the housing unit. Preferably, the at least one fluid channel element can be fastened to the outside of the housing unit via the at least one connecting element. Preferably, the connection unit has at least one further connecting element for connecting, in particular mechanically, the at least one fluid channel element to the housing unit, preferably to the at least one connecting element of the connection unit. The at least one further connecting element is preferably designed to correspond to the at least one connecting element of the connecting unit. Preferably, the at least one further connecting element is arranged on the at least one fluid channel element, in particular detachably, preferably non-destructively detachably, or is designed integrally with the at least one fluid channel element. The at least one further connecting element can be designed, for example, as a latching element, as a Velcro element, for example as a Velcro strip or the like, as a bayonet fastening element, as a clamping element, as a screw element, as a magnetic element or as any other connecting element which appears to be useful to a person skilled in the art. It is conceivable that the at least one connecting element and/or the at least one further connecting element are/is provided for sealing the fluid connection between the fluid unit and the housing unit. For example, the at least one connecting element and/or the at least one further connecting element, preferably for sealing the fluid connection between the fluid unit and the housing unit, are/is formed from an elastic material, preferably from a rubber-like material. The at least one fluid channel element is preferably tubular, in particular trunk-shaped or snorkel-shaped. It is conceivable that the at least one fluid channel element is designed as an extendable element. For example, the at least one fluid channel element designed as an extendable element can be arranged at least substantially completely in the housing unit or the fluid unit, in particular in a state of the fluid channel element in which the fluid channel element is free of a connection to the fluid unit or the housing unit. The at least one fluid channel element is preferably rigidly connected to the housing unit, in particular in a state of the at least one fluid channel element connected to the housing unit. Alternatively, however, it is also conceivable that the at least one fluid channel element, in particular in the state of the at least one fluid channel element connected to the housing unit, is arranged movably, in particular rotatably, on the housing unit. The at least one fluid channel element is preferably arranged movably, in particular rotatably, on the fluid unit, in particular in a state of the fluid channel element connected to the fluid unit. Alternatively, however, it is also conceivable that the at least one fluid channel element is rigidly connected to the fluid unit, in particular in the state of the fluid channel element connected to the fluid unit. The at least one fluid channel element is preferably designed as a fluid connection channel between the cooling air inlet section and the fluid unit. The fluid channel element is designed, for example, from a plastic, in particular a rubber-elastic plastic, or the like. The connection unit preferably has at least one additional connecting element for connecting, in particular mechanically, the at least one fluid channel element to the fluid unit. The at least one additional connecting element can be designed, for example, as a latching element, as a Velcro element, for example as a Velcro strip or the like, as a bayonet fastening element, as a clamping element, as a screw element, as a magnetic element or as any other connecting element that appears to be useful to a person skilled in the art. The additional connecting element is preferably arranged on the at least one fluid channel element, preferably on a side of the at least one fluid channel element facing away from a further side of the at least one fluid channel element on which the at least one further connecting element is preferably arranged. The fluid unit preferably has at least one housing connecting element for connecting, in particular mechanically, the fluid unit to the at least one fluid channel element or the at least one connecting element. In particular, the housing connecting element is designed to correspond to the at least one additional connecting element and/or the at least one connecting element. The housing connecting element can be designed, for example, as a latching element, as a Velcro element, for example, as a Velcro strip or the like, as a bayonet fastening element, as a clamping element, as a screw element, as a magnetic element or the like. Advantageously, a particularly targeted air flow can be achieved between the fluid unit and the cooling air inlet section. Advantageously, a particularly efficient air flow can be achieved, for example for an extraction function and/or a cooling function. Advantageously, the fluid channel element and in particular the fluid unit can be removed from the housing unit particularly easily and conveniently. Advantageously, the fluid channel element can be cleaned particularly conveniently in a state of the fluid channel element dismantled from the housing unit. Advantageously, the fluid channel element can be replaced particularly conveniently and easily. Advantageously, the fluid unit can be cleaned particularly easily and conveniently. Advantageously, a maintenance of a cooling function can be supported particularly easily and conveniently.

It is also proposed that the machine tool apparatus comprise the fluid unit, which comprises at least one filter element, in particular the one previously mentioned. In particular, the filter element is designed to filter the ablation that can be generated during the machining of a workpiece from the air flow that passes through the fluid unit. The filter element is preferably designed as a dust filter. The filter element is designed, for example, as a dry filter, for example as a lamella filter, preferably as a cartridge filter, as an air filter screen, as a cassette filter or the like, as a cyclone filter, as a liquid filter or the like. Alternatively or additionally, it is conceivable that the filter element is designed as a suspended matter filter, in particular for pathogens, pollen or the like, or as a gas filter. Advantageously, particularly contamination-free air can be provided at the cooling air inlet section. Advantageously, a particularly efficient and gentle cooling function can be realized. Advantageously, damage to components inside the housing unit can be counteracted particularly effectively.

In addition, it is proposed that the fluid unit comprise at least one dust collection container, in particular the one previously mentioned. In particular, the dust collection container is designed to collect the ablation during the machining of a workpiece. Preferably, the dust collection container is provided for receiving an ablation filtered out of the air flow conducted through the fluid unit, in particular one that can be generated during the machining of a workpiece. It is conceivable that the filter element is arranged at least substantially entirely within the dust collection container. By “at least substantially complete” may be meant at least 50%, preferably at least 75%, and more preferably at least 90% of a total volume and/or a total mass of an object. Advantageously, an undesired spread of ablation can be counteracted. Advantageously, repeated aspiration of ablation can be counteracted. Advantageously, a particularly efficient ablation extraction can be achieved. Advantageously, a particularly efficient air flow can be achieved in the machine tool apparatus. Advantageously, a particularly efficient and gentle cooling function can be realized.

Furthermore, it is proposed that the dust collection container have a fluid outlet section which is connected to the cooling air inlet section of the housing unit, in particular fluidically. Preferably, the at least one housing connection element is disposed at the fluid outlet section. Preferably, the fluid outlet section of the dust collection container is fluidically connected to the cooling air inlet section of the housing unit by means of the connection unit, in particular via the at least one fluid channel element.

It is further proposed that the fluid unit be designed as an extraction unit for extracting an ablation that can be generated during a machining of a workpiece and is free from a fan element. Preferably, the fluid unit, in particular in at least one embodiment example, is free of a fan element for generating an air flow for extracting an ablation that can be generated during a machining of a workpiece. Preferably, the fluid unit designed as an extraction unit has at least one ablation port, which is provided for receiving the ablation that can be generated during the machining of a workpiece. The ablation port is connected, for example, to an ablation guide element, in particular an ablation guide tube or the like, of the machine tool, preferably at least fluidically. Alternatively, it is also conceivable that the fluid unit has the ablation guide element. The ablation guide element is preferably directed toward an ablation section of the machine tool, in particular the machine tool apparatus. In particular, the fluid channel of the fluid unit extends from the ablation port to a fluid outlet port of the fluid unit. The fluid outlet port of the fluid unit is preferably fluidly connected to the cooling air inlet section of the housing unit through the connecting unit in a state of the fluid unit connected to the housing unit. The fluid outlet section of the dust collection container is preferably defined by the fluid outlet port of the fluid unit. Alternatively, it is also conceivable that the fluid outlet port of the fluid unit is arranged separately from the fluid outlet section of the dust collection container. It is conceivable that the machine tool apparatus has at least one additional fluid passage port, in particular for drawing in air and/or for discharging air. Advantageously, the air flow provided for extraction can be used for cooling. Advantageously, the air flow can be used particularly efficiently for several functions.

Furthermore, it is proposed that the machine tool apparatus comprise a fan unit for generating an air flow, in particular the previously mentioned air flow, between the fluid unit and the interior of the housing unit. The fan unit preferably has at least one fan wheel. In particular, the fan unit is provided for generating the air flow for extracting an ablation that can be generated during the machining of a workpiece. In particular, the fan unit is provided for generating the air flow for cooling the interior of the housing unit. Preferably, the fan unit is provided to draw in air at the ablation port and direct it into the interior of the housing unit through the fluid unit and the cooling air inlet section of the housing unit. Advantageously, a coherent air flow can be used for a cooling function in the housing unit and for the extraction of an ablation. Advantageously, a particularly efficient machine tool apparatus can be provided.

It is also proposed that in at least one operating condition, the fan unit draw air into the fluid unit, in particular into the dust collection container. Preferably, the fan unit is arranged fluidically on a side of the cooling air outlet port of the fluid unit facing away from the ablation port. In particular, in at least one operating state, the fan unit draws air into the fluid unit via the ablation port, preferably in the direction of the cooling air inlet section of the housing unit. Advantageously, contamination and/or damage to the fan unit can be counteracted. Advantageously, the machine tool apparatus can be operated in a particularly gentle manner for extraction and/or cooling.

In addition, it is proposed that the fan unit be at least partially arranged in the housing unit. By the fact that a unit is at least partially arranged in a further unit, it can be understood here that in particular at least 10%, preferably at least 25%, preferably at least 50% of a total volume and/or a total mass of the unit is/are arranged in the further unit. Preferably, the fan unit is at least substantially completely disposed within the housing unit. Advantageously, a fan unit arranged in the housing unit can be used for an extraction function and a cooling function in the housing unit.

Furthermore, it is proposed that the machine tool apparatus, in particular in at least one embodiment example, comprise a further fan unit for generating the air flow, which is arranged on the housing unit, preferably at least partially in the housing unit. The further fan unit preferably has one fan wheel or alternatively several fan wheels. The further fan unit is provided, in particular, for generating the air flow for extracting an ablation that can be generated during the machining of a workpiece. The further fan unit is preferably provided for generating the air flow for cooling the interior of the housing unit. Preferably, the further fan unit is provided to draw in air at the ablation port and direct it into the interior of the housing unit through the fluid unit and the cooling air inlet section of the housing unit. The further fan unit is arranged in particular in such a way that it blows air into the dust collection container in at least one operating state. Preferably, the fan unit and the further fan unit, in particular in at least one embodiment example, can generate a coherent air flow, preferably for cooling the interior of the housing unit and/or for extracting an ablation that can be generated during machining of a workpiece. The further fan unit is preferably arranged, in particular fluidically, between a tool holder section of the machine tool, preferably of the machine tool housing, in particular of the housing unit, and the ablation port. The further fan unit is preferably arranged, in particular fluidically, between a tool holder of the machine tool, preferably of the machine tool housing, and the ablation port. Alternatively or additionally, it is conceivable that the machine tool apparatus has an additional fan unit that is at least partially arranged in the fluid unit. Advantageously, a particularly efficient cooling function and/or extraction function can be achieved.

It is also proposed that the connecting unit be designed as pincer. Advantageously, the fluid unit can be fastened to the housing unit in a particularly secure and/or space-saving manner. A particularly even load distribution can be achieved when the fluid unit is fastened to the housing unit. In particular, the fluid unit can be fastened to the housing unit in a pincer-like manner. Preferably, the connection unit has at least two pincer elements for fastening to the housing unit. In particular, the pincer elements are arranged on the fluid unit, preferably designed integrally with at least part of the fluid unit. In a state of the fluid unit fastened to the housing unit, the pincer elements are preferably arranged on sides of the housing unit facing away from each other, in particular the pincer elements are in contact with the housing unit on sides facing away from each other. At least one pincer element of the pincer elements is arranged at the cooling air inlet section in a state of the fluid unit fastened to the housing unit. In particular, the at least one pincer element has a fluid channel. The fluid channel of the pincer element preferably fluidly connects the cooling air inlet section with the dust collection container of the fluid unit, preferably in a dust-tight manner. Preferably, in particular in at least one embodiment example, two connecting elements are arranged on the housing unit, preferably on sides of the housing unit facing away from each other, which are provided in particular to cooperate with the pincer elements for fastening the fluid unit to the housing unit. It is conceivable that an elastic deflection of the pincer elements relative to one another, in particular when the fluid unit is mounted on the housing unit, can generate a clamping force for fastening the fluid unit to the housing unit.

In addition, it is proposed that the machine tool apparatus have a sealing unit for dividing an interior of the housing unit into a positive pressure area and a negative pressure area. The air flow can be guided particularly effectively. Advantageously, undesirable backflows can be counteracted. A particularly high cooling effect can be achieved at desired locations in the housing unit. A volume flow of cooling air can be increased. A particularly high extraction effect can be achieved. In particular, the sealing unit is designed to counteract undesirable backflow of the airflow in the housing unit. Preferably, the sealing unit is provided to reduce a maximum flow cross-sectional area relative to a maximum cross-sectional area of the housing unit at a position of the sealing unit. In particular, the cross-sectional area is at least substantially perpendicular to the main extension axis of the housing unit, preferably a main extension axis of the machine tool. By “substantially perpendicular” may be understood an orientation of a direction relative to a reference direction, wherein the direction and the reference direction, in particular as viewed in a projection plane, enclose an angle of 90° and the angle has a maximum deviation of in particular less than 8°, advantageously less than 5° and particularly advantageously less than 2°. The cross-sectional area of the housing unit is limited in particular by an inner wall of the housing unit. Preferably, the sealing unit is arranged between a drive housing of the machine tool apparatus and the housing unit, preferably the inner wall of the housing unit. Preferably, the sealing unit seals a section between the housing unit and the drive housing, in particular at least with respect to the main extension axis in radial direction. The sealing unit preferably has a sealing element. Alternatively, it is also conceivable that the sealing unit has several sealing elements. The sealing element is preferably formed from an elastic material, in particular a rubber-elastic material. Alternatively, however, it is also conceivable for the sealing element to be designed from another material that appears to be useful to a person skilled in the art. Alternatively or additionally, it is also conceivable that at least part of the sealing unit is formed by the housing unit. The sealing element is annular, for example, preferably designed as a rubber ring or a rubber ring segment. The sealing element preferably encloses the drive housing at least substantially completely, preferably completely, in particular at least as viewed in the radial direction. By the fact that an object at least substantially completely encloses a further object, it is to be understood in particular that the further object is enclosed by the further object at least in an angular range of at least 180°, preferably of at least 270°, preferably of at least 330° and particularly preferably of at least 350°. The drive housing is provided in particular to accommodate a drive unit.

Furthermore, it is proposed that the machine tool apparatus comprise a drive housing, in particular the aforementioned one, with at least one ventilation port through which the positive pressure area is connected to the negative pressure area. Advantageously, a particularly high volume flow can be realized through the drive housing. Particularly efficient cooling of the drive unit can be achieved. It is conceivable that the drive housing has several ventilation ports or only one ventilation port. Preferably, the sealing unit is arranged such that the entire air flow is guided through the at least one ventilation port. In particular, the fan unit can generate a negative pressure in the negative pressure area in at least one operating state. In particular, the fan unit can generate a positive pressure in the positive pressure range in at least one operating state.

It is also proposed that an air flow from the tool holder section be guided through the dust collection container, the filter element, the connecting unit and the cooling air inlet section, and then through electronics, a drive unit, in particular for driving the tool, and the fan unit, preferably exactly in the order given here, wherein deviating arrangements are also conceivable, to the cooling air outlet section. This can provide a particularly advantageous air flow for the removal of shredding material and/or for cooling machine components. If necessary, other elements can also be introduced into the airflow path, such as electrical switches of the machine tool apparatus. In particular, the air initially flows with respect to the main extension axis from the tool in the direction of the battery, in particular to the rear, in order to then change the flow direction with respect to the main extension axis in a vicinity of the cooling air inlet section, in particular to reverse it, preferably by at least substantially 180°.

Furthermore, a machine tool, in particular the machine tool previously mentioned, is proposed with a machine tool apparatus according to the disclosure. The machine tool preferably has at least the electronics. The machine tool preferably has the drive unit. The drive unit is preferably designed as an electric motor. The electronics are provided in particular for controlling and/or regulating the drive unit. For example, the machine tool housing may have one or more housing shells. The machine tool housing preferably has at least one motor mounting area for mounting the drive unit. The drive housing is arranged in particular in the motor mounting area. The machine tool housing, in particular the housing unit, preferably has at least one holder section for the electronics. In particular, the machine tool has the tool holder for receiving a tool, in particular the tool already mentioned. The drive unit is provided in particular for driving the tool arranged on the tool holder. The machine tool is preferably designed as a hand-held machine tool, in particular as a grinding machine, preferably as an orbital sander or as a rotary sander, as a jigsaw, as an oscillating saw, as a circular saw, as an angle grinder, or as any other machine tool that appears to be useful to a person skilled in the art. Alternatively, however, it is also conceivable that the machine tool is designed as a household machine, in particular a kitchen machine or a cleaning machine, as a garden machine, for example a mowing machine, or the like. The machine tool housing preferably has at least one cooling air outlet section. The cooling air outlet section of the housing unit corresponds in particular to the cooling air inlet section of the machine tool housing. Preferably, the drive unit and/or the electronics are/is fluidically arranged between the cooling air outlet section of the machine tool, in particular the cooling air outlet section of the housing unit, and the cooling air inlet section of the housing unit. The cooling air inlet section of the housing unit of the machine tool apparatus preferably corresponds to a cooling air inlet section of the machine tool housing. It is also conceivable that the machine tool apparatus comprises the machine tool housing, in particular the machine tool housing corresponds to the housing unit. The air flow that can be generated by means of the fan unit preferably passes over the drive housing and/or the holder area for the electronics. The fan unit is provided in particular for generating the air flow for cooling the electronics and the drive unit in the machine tool housing. The fan unit is preferably arranged on a side of the drive unit of the machine tool facing away from the cooling air inlet section. Advantageously, a machine tool can be provided which, in a particularly compact design, enables a cooling function at least for the electronics and the drive unit of the machine tool and an extraction function for any ablation.

Furthermore, the disclosure proceeds from a method of operating a machine tool according to the disclosure. It is proposed that air be exhausted from a tool holder section of the machine tool and blown out into a near area of the tool holder section. Preferably, a workpiece is machined in one method step by means of the tool arranged on the machine tool. Preferably, in a further method step, air is extracted from the tool holder section by means of the fan unit and/or the further fan unit. In particular, in the further method step, the air is directed via the fluid unit through the cooling air inlet section of the housing unit, in particular the cooling air inlet section of the machine tool housing, into the interior of the housing unit, preferably into the machine tool housing. Preferably, in the further method step, the air is guided to the cooling air outlet section of the machine tool housing via the electronics and/or via the drive unit of the machine tool. In particular, in the further method step, the air is blown through the cooling air outlet section onto the tool holder section. It is conceivable that the method step and the further method step run simultaneously. Advantageously, a coherent air flow can be used to clean a processing area from ablation, for cooling and for extraction.

The machine tool apparatus according to the disclosure, the machine tool according to the disclosure and/or the method according to the disclosure shall/should not be limited here to the application and embodiment described above. In particular, the machine tool apparatus according to the disclosure, the machine tool according to the disclosure, and/or the method according to the disclosure may/may have a number of individual elements, components, and units, as well as process steps, that deviates from a number of individual elements, components, and units, as well as method steps, described herein in order to fulfill a mode of operation described herein. Moreover, for the ranges of values indicated in this disclosure, values lying within the aforementioned limits are also intended to be considered to be disclosed and usable as desired.

### BRIEF DESCRIPTION OF THE DRAWINGS

Further advantages follow from the following description of the drawings. Four embodiment examples are shown in the drawing. The drawings, the description, and the claims contain numerous features in combination. A person skilled in the art will appropriately also consider the features individually and combine them into additional advantageous combinations.

The following are shown:

FIG. 1 a machine tool according to the disclosure with a machine tool apparatus according to the disclosure in a schematic representation,

FIG. 2 a schematic sequence of a method according to the disclosure for an operation of the machine tool apparatus,

FIG. 3 the machine tool with a machine tool apparatus according to the disclosure in a first alternative design in a schematic representation,

FIG. 4 a machine tool according to the disclosure with a machine tool apparatus according to the disclosure in a second alternative design in a schematic representation,

FIG. 5 a machine tool according to the disclosure with a machine tool apparatus according to the disclosure in a third alternative design in a schematic representation,

FIG. 6 a machine tool according to the disclosure with a machine tool apparatus according to the disclosure in a fourth alternative design in a schematic representation,

FIG. 7 a cross-sectional view of the machine tool shown in FIG. 6,

FIG. 8 the machine tool from FIG. 6 in a further cross-sectional view,

FIG. 9 a machine tool according to the disclosure with a machine tool apparatus according to the disclosure in a fifth alternative design in a schematic representation,

FIG. 10 a cross-sectional view of part of the machine tool shown in FIG. 9,

FIG. 11 a further part of the machine tool from FIG. 9 in a perspective view and

FIG. 12 an air bypass on a housing unit of the machine tool in a perspective view.

### DETAILED DESCRIPTION

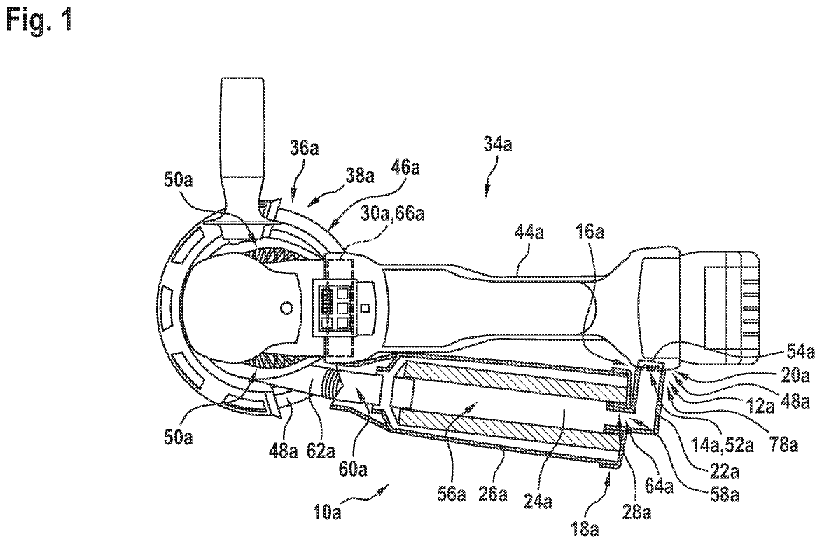

FIG. 1 shows a machine tool 34a. The machine tool 34a is designed as a hand-held machine tool. The machine tool 34a is designed as a rotary sander. Alternatively, it is also conceivable that the machine tool 34a is designed as another grinding machine, in particular as an orbital sander, as a jigsaw, as an oscillating saw, as a circular saw, as an angle grinder, or as any other machine tool that appears to be useful to a person skilled in the art. Furthermore, it is alternatively conceivable that the machine tool 34a is designed as a household machine, in particular a kitchen machine or a cleaning machine, or as a garden machine, for example a mowing machine, or the like.

The machine tool 34a includes at least one electronic system (not shown here). The machine tool 34a has at least one drive unit (not shown here). The drive unit is designed as an electric motor. The electronics are designed to control and/or regulate the drive unit. The machine tool 34a includes a machine tool housing 44a. For example, the machine tool housing 44a may include one or more housing shells. The machine tool housing 44a includes at least one motor mounting area for mounting the drive unit. The machine tool housing 44a includes at least one holder section for the electronics. The machine tool 34a includes a tool holder 46a for receiving a tool 48a. The tool 48a is designed as a grinding plate. The drive unit is provided for driving the tool 48a arranged at the tool holder 46a.

The machine tool housing 44a includes two cooling air outlet sections 50a. Alternatively, it is also conceivable that the machine tool housing 44a has only one cooling air outlet section or more than two cooling air outlet sections. The machine tool housing 44a includes a cooling air inlet section 52a. Alternatively, however, it is conceivable that the machine tool housing 44a includes more than one cooling air inlet section, such as two cooling air inlet sections, three cooling air inlet sections, or more than three cooling air inlet sections. The drive unit is fluidly disposed between the cooling air outlet sections 50a of the machine tool housing 44a and the cooling air inlet section 52a of the machine tool housing 44a. The electronics are fluidly disposed between the cooling air outlet sections 50a of the machine tool housing 44a and the cooling air inlet section 52a of the machine tool housing 44a.

The machine tool 34a has a machine tool apparatus 10a. The machine tool apparatus 10a is partially detachably fastened to the machine tool 34a, particularly to the machine tool housing 44a. The machine tool apparatus 10a has at least one housing unit 12a. The machine tool apparatus 10a, in particular at least the housing unit 12a, is at least partially integrally designed with the machine tool housing 44a. The housing unit 12a is at least partially part of the machine tool housing 44a. The housing unit 12a includes a cooling air inlet section 14a. The cooling air inlet section 14a of the housing unit 12a corresponds to the cooling air inlet section 52a of the machine tool housing 44a. It is also conceivable that the machine tool apparatus 10a comprises the machine tool housing 44a. Alternatively, it is also conceivable that the machine tool apparatus 10a is completely detachable from the machine tool 34a, in particular detachable in a non-destructive manner.

The machine tool apparatus 10a has at least one connecting unit 16a for fluidly connecting the cooling air inlet section 14a of the housing unit 12a to a fluid unit 18a on the outside 20a of the housing unit 12a. The connection unit 16a is provided for detachable, preferably non-destructively detachable, fluid connection of the cooling air inlet section 14a of the housing unit 12a to the fluid unit 18a on the outside 20a of the housing unit 12a. The connecting unit 16a is mechanically connected to the fluid unit 18a when the fluid unit 18a is fluidically connected to the cooling air inlet section 14a of the housing unit 12a. The cooling air intake section 14a is defined by one or more air intake slots of the housing unit 12a. The cooling air outlet sections 50a are each defined by one or more air outlet slots of the machine tool housing 44a. The connection unit 16a has at least one connecting element 54a. The cooling air inlet section 14a of the housing unit 12a is connected to the fluid unit 18a, in particular mechanically, by the connecting element 54a.

The connecting element 54a is designed as a latching element, for example as a latching lug or the like. Alternatively, it is conceivable that the connecting element 54a is designed as a Velcro element, for example as a Velcro or the like, as a bayonet fastening element, as a clamping element, as a screw element, as a magnetic element or as any other connecting element which appears to be useful to a person skilled in the art. The connecting element 54a is integrally designed with at least a portion of the housing unit 12a, in particular with a portion of the machine tool housing 44a. Alternatively, it is also conceivable that the connecting element 54a is designed separately from the housing unit 12a, in particular from the machine tool housing 44a, and can be preferably detachably fastened to the housing unit 12a.

The connection unit 16a includes a fluid channel element 22a for fluidly connecting the cooling air inlet section 14a to the fluid unit 18a. The fluid unit 18a and the fluid channel element 22a are shown in a sectional view in FIG. 1. Alternatively, it is also conceivable that the connection unit 16a comprises more than one fluid channel element, for example two fluid channel elements, three fluid channel elements or more than three fluid channel elements. Furthermore, it is alternatively conceivable that the connection unit 16a is free of a fluid channel element. The fluid channel element 22a is rigidly connected to the housing unit 12a in a state of the fluid channel element 22a connected to the housing unit 12a. The fluid channel element 22a is provided as a fluid connection channel between the cooling air inlet section 14a of the housing unit 12a, in particular the cooling air inlet section 52a of the machine tool housing 44a, and the fluid unit 18a. The fluid channel element 22a is designed, for example, from a plastic, in particular a rubber-elastic plastic, or the like. The fluid channel element 22a is detachably fastened to the outside 20a of the housing unit 12a. Alternatively, it is conceivable that the fluid channel element 22a is integrally designed with at least a portion of the housing unit 12a. Alternatively, it is also conceivable that the fluid channel element 22a, in particular in the state of the fluid channel element 22a connected to the housing unit 12a, is arranged movably, in particular rotatably, on the housing unit 12a.

The fluid channel element 22a is fastened to the outside 20a of the housing unit 12a by means of the connecting element 54a. The connection unit 16a has at least one further connecting element (not shown here) for connecting, in particular mechanically, the fluid channel element 22a to the housing unit 12a, preferably to the connecting element 54a. The at least one further connecting element is designed to correspond to the connecting element 54a. The at least one further connecting element is designed integrally with the fluid channel element 22a. Alternatively, it is also conceivable that the at least one further connecting element can be detachably fastened to the fluid channel element 22a. The at least one further connecting element is designed as a latching element. Alternatively, however, it is also conceivable that the at least one further connecting element is designed as a Velcro element, for example as a Velcro strip or the like, as a bayonet fastening element, as a clamping element, as a screw element, as a magnetic element or as any other connecting element that appears to be useful to a person skilled in the art.

The fluid channel element 22a is designed to be tubular, in particular snorkel-shaped. The fluid channel element 22a is rigidly formed. Alternatively, it is conceivable that the fluid channel element 22a is formed of an elastic material. Alternatively, it is conceivable that the at least one fluid channel element 22a is designed as an extendable element. For example, the at least one fluid channel element 22a designed as an extendable element is at least substantially completely disposable in the housing unit 12a or the fluid unit 18a, in particular in a state of the fluid channel element 22a in which the fluid channel element 22a is free of a connection with the fluid unit 18a or the housing unit 12a.

The fluid channel element 22a is movably, in particular rotatably, arranged on the fluid unit 18a in a state of the fluid channel element 22 being connected to the fluid unit 18a. Alternatively, however, it is also conceivable that the fluid channel element 22a is rigidly connected to the fluid unit 18a in the state of the fluid channel element 22a being connected to the fluid unit 18a.

The connection unit 16a has at least one additional connecting element (not shown here) for connecting, in particular mechanically, the fluid channel element 22a to the fluid unit 18a. The additional connecting element can be designed, for example, as a latching element, as a Velcro element, for example, as a Velcro strip or the like, as a bayonet fastening element, as a clamping element, as a screw element, as a magnetic element or as any other connecting element that appears to be useful to a person skilled in the art. The additional connecting element is arranged on the fluid channel element 22a, in particular on a side 58a of the fluid channel element 22 facing away from a further side 78a of the fluid channel element 22a on which the further connecting element is arranged. The additional connecting element is integrally designed with the fluid channel element 22a. Alternatively, however, it is also conceivable that the additional connecting element is arranged on the fluid channel element 22a in a detachable manner, in particular in a non-destructively detachable manner.

The fluid unit 18a preferably has at least one housing connecting element (not shown here) for connecting, in particular mechanically, the fluid unit 18a to the fluid channel element 22a. The housing connecting element is designed to correspond to the at least one additional connecting element. The housing connecting element can be designed, for example, as a latching element, as a Velcro element, for example, as a Velcro strip or the like, as a bayonet fastening element, as a clamping element, as a screw element, as a magnetic element or the like. Alternatively, it is also conceivable that the fluid unit 18a can be connected directly to the connecting element 54a of the connecting unit 16a by means of the housing connecting element.

The machine tool apparatus 10a has at least the fluid unit 18a. The fluid unit 18a has at least one fluid channel 56a. The fluid unit 18a is provided for use in extracting an amount of ablation during machining of a workpiece, preferably by means of the tool 48a arranged on the machine tool 34a. The fluid unit 18a has at least one filter element 24a. The filter element 24a is provided to filter the ablation that can be generated during the machining of a workpiece from an air stream passed through the fluid unit 18a. The filter element 24a is designed as a dust filter. The filter element 24a is designed as a cartridge filter. Alternatively, it is also conceivable that the filter element 24a is designed as another dry filter, for example an air filter screen, a cassette filter or the like, a cyclone filter, a liquid filter or the like. Alternatively or additionally, it is conceivable that the filter element 24a is designed as a suspended matter filter, in particular for pathogens, pollen or the like, or as a gas filter.

The fluid unit 18a has at least one dust collection container 26a. The dust collection container 26a is provided to collect the ablation that can be generated during the machining of a workpiece. The dust collection container 26a is provided for receiving an ablation filtered from the air flow conducted through the fluid unit 18a, in particular one that can be generated during the machining of a workpiece.

The dust collection container 26a includes a fluid outlet section 28a. The fluid outlet section 28a is connected to the cooling air inlet section 14a of the housing unit 12a, in particular at least fluidically. The at least one housing connection element is disposed at the fluid outlet section 28a. The fluid outlet section 28a of the dust collection container 26a is fluidly connected to the cooling air inlet section 14a of the housing unit 12a, in particular the cooling air inlet section 52a of the machine tool housing 44a, by means of the connection unit 16a, in particular via the fluid channel element 22a.

The fluid unit 18a is designed as an extraction unit for extracting an abrasion that can be generated during a machining of a workpiece, and is formed free from a fan element. The fluid unit 18a designed as an extraction unit is designed as a passive extraction unit. The fluid unit 18a is devoid of a fan element for generating an air flow for extracting an ablation that can be generated during a machining operation of a workpiece. The fluid unit 18a, which is designed as an extraction unit, has at least one material ablation port 60a, which is provided in particular for receiving the ablation that can be generated during machining of a workpiece. The ablation port 60a is connected to an ablation guide element 62a, in particular an ablation guide tube, of the machine tool 34a, preferably at least fluidically. Alternatively, it is also conceivable that the fluid unit 18a comprises the ablation guide element 62a.

The ablation guide element 62a is directed toward an ablation section of the machine tool 34a, in particular the machine tool apparatus 10a. The fluid channel 56a of the fluid unit 18a extends from the ablation port 60a to a fluid outlet port 64a of the fluid unit 18a. The filter element 24a is disposed between the ablation port 60a and the fluid outlet port 64a of the fluid unit 18a. In one operation of the machine tool 34a, in particular of the machine tool apparatus air together with the ablation is guided into the fluid unit 18a via the ablation port 60a, wherein in the fluid unit 18a the ablation is separated from the air by means of the filter element 24a and the air is guided to the fluid outlet port 64a of the fluid unit 18a. The ablation remains in the dust collection container 26a. The fluid outlet section 28a of the dust collection container 26a is defined by the fluid outlet port 64a of the fluid unit 18a. The fluid outlet port 64a of the fluid unit 18a is fluidly connected to the cooling air inlet section 14a of the housing unit 12a through the connecting unit 16a in a state of the fluid unit 18a connected to the housing unit 12a.

The machine tool apparatus 10a includes a fan unit 30a for generating the air flow between the fluid unit 18a and an interior of the housing unit 12a. The fan unit 30a has at least one fan wheel 66a. The fan unit 30a is provided for generating the air flow for extracting an ablation that can be generated when machining a workpiece. The fan unit 30a is provided for generating the air flow for cooling the interior of the housing unit 12a, in particular the electronics and the drive unit. The fan unit 30a is provided to generate the airflow for cooling the electronics and drive unit in the machine tool housing 44a. The fan unit 30a is provided for sucking air at the ablation port 60a and directing it through the fluid unit 18a and the cooling air inlet section 14a of the housing unit 12a into the interior of the housing unit 12a, in particular an interior of the machine tool housing 44a. The fan unit 30a is arranged on a side of the drive unit facing away from the cooling air inlet section 14a.

The fan unit 30a draws air into the fluid unit 18a in at least one operating condition. The fan unit 30a is fluidly arranged on a side of the fluid port 64a of the fluid unit 18a opposite to the ablation port 60a. In at least one operating condition, the fan unit 30a draws air into the fluid unit 18a via the ablation port 60a toward the cooling air inlet section 14a of the housing unit 12a. The fan unit 30a is at least partially disposed within the housing unit 12a. The fan unit 30a is disposed at least substantially entirely within the housing unit 12a, particularly within the machine tool housing 44a.

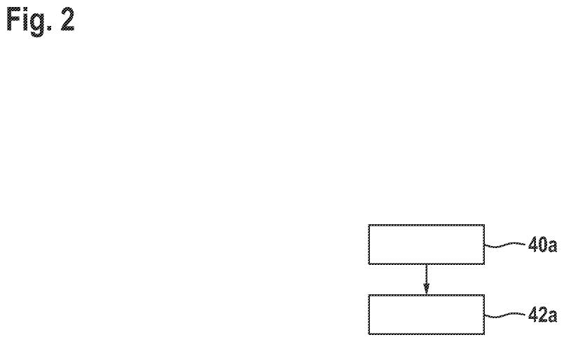

FIG. 2 shows a schematic flow of a method for operating the machine tool 34a. In a method step 40a, a workpiece is machined by means of the tool 48a arranged on the machine tool 34a.

In a further method step 42a, air is extracted from a tool holder section 36a of the machine tool 34a at least by means of the fan unit 30a. In the further method step 42a, the air is directed via the fluid unit 18a through the cooling air inlet section 14a of the housing unit 12a, in particular the cooling air inlet section 52a of the machine tool housing 44a, into the interior of the housing unit 12a, preferably into the machine tool housing 44a. In the further method step 42a, the air is guided to the cooling air outlet sections 50a via the electronics and/or via the drive unit of the machine tool 34a. Air is exhausted from the tool holder section 36a and blown out into a near area 38a of the tool holder section 36a. The air is blown through the cooling air outlet sections 50a onto the tool holder section 36a in the further method step 42a. It is conceivable that the method step 40a and the further method step 42a run simultaneously.

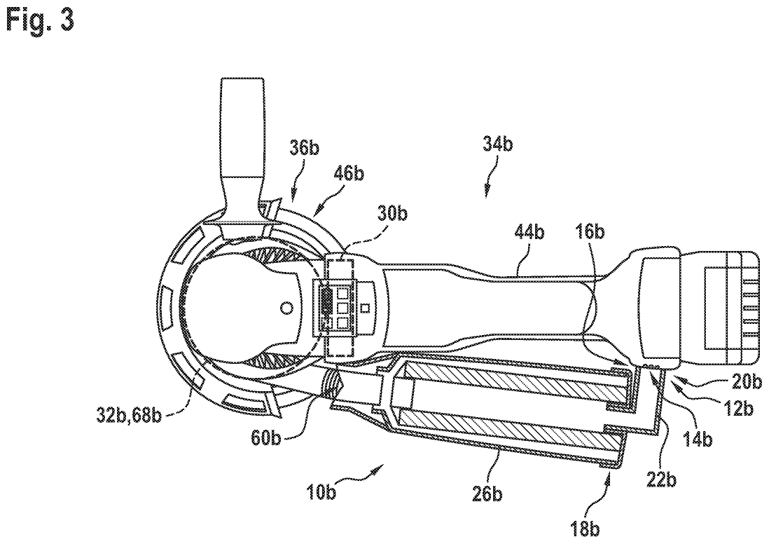

FIGS. 3 through 5 show further embodiment examples of the disclosure. The following descriptions and the drawings are essentially limited to the differences between the embodiment examples, wherein with regard to components with the same designation, in particular with regard to components with the same reference numbers, reference can in principle also be made to the drawings and/or the description of the other embodiment examples, in particular of FIGS. 1 and 2. To distinguish the embodiment examples, the letter a is placed after the reference numbers of the embodiment example in FIGS. 1 and 2. In the embodiment examples of FIGS. 3 to 5, letter a is replaced by letters b through d.

FIG. 3 shows a machine tool 34b. The machine tool 34b is designed as a hand-held machine tool. The machine tool 34b is designed as a rotary sander. Alternatively, it is also conceivable that the machine tool 34b is designed as another grinding machine, in particular as an orbital sander, as a jigsaw, as an oscillating saw, as a circular saw, as an angle grinder, or as any other machine tool 34b that appears to be useful to a person skilled in the art. Furthermore, it is alternatively conceivable that the machine tool 34b is designed as a household machine, in particular a food processor or a cleaning machine, as a garden machine, for example a mowing machine, or the like.

The machine tool 34b has a machine tool apparatus 10b. The machine tool apparatus has at least one housing unit 12b. The housing unit 12b includes a cooling air inlet section 14b. The machine tool apparatus 10b has at least one connecting unit 16b for fluidly connecting the cooling air inlet section 14b to a fluid unit 18b on the outside 20b of the housing unit 12b. The connection unit 16b includes a fluid channel element 22b for fluidly connecting the cooling air inlet section 14b to the fluid unit 18b. The fluid unit 18b and the fluid channel element 22b are shown in a sectional view in FIG. 3.

The machine tool apparatus 10b has at least the fluid unit 18b. The machine tool apparatus 10b includes a fan unit 30b for generating an air flow between the fluid unit 18b and an interior of the housing unit 12b. The fan unit 30b is arranged on the housing unit 12b, in particular on a machine tool housing 44b of the machine tool 34b, preferably at least partially in the housing unit 12b. The fan unit 30a is arranged on a side of a drive unit of the machine tool 34b opposite to the cooling air inlet section 14b.

The machine tool apparatus 10b has another fan unit 32b for generating the air flow. The further fan unit 32b is arranged on the housing unit 12b, preferably at least partially in the housing unit 12b. The further fan unit 32b has a fan wheel 68b or alternatively several fan wheels. The further fan unit 32b is provided for generating the air flow for extracting an ablation that can be generated when machining a workpiece. The further fan unit 32b is provided for generating the air flow for cooling an interior of the housing unit 12b. The further fan unit 32b is provided for sucking air at an ablation port 60b and directing it into the interior of the housing unit 12b through the fluid unit 18b and the cooling air inlet section 14b of the housing unit 12b. The further fan unit 32b is arranged such that the further fan unit 32b blows air into a dust collection container 26b of the fluid unit 18b in at least one operating state. A coherent air flow can be generated by the fan unit 30b and the further fan unit 32b, in particular for cooling the interior of the housing unit 12b and/or for extracting an ablation that can be generated during machining of a workpiece. The further fan unit 32b is arranged, in particular fluidically, between a tool holder section 36b of the machine tool 34b, preferably of the machine tool housing 44b, in particular of the housing unit 12b, and the ablation port 60b. The further fan unit 32b is arranged, in particular in terms of fluid technology, between a tool holder 46b of the machine tool 34b, preferably of the machine tool housing 44b, and the ablation port 60b. Alternatively or additionally, it is conceivable that the machine tool apparatus 10b comprises an additional fan unit arranged at least partially in the fluid unit 18b. Alternatively, it is also conceivable that the machine tool apparatus 10b comprises only the further fan unit 32b.

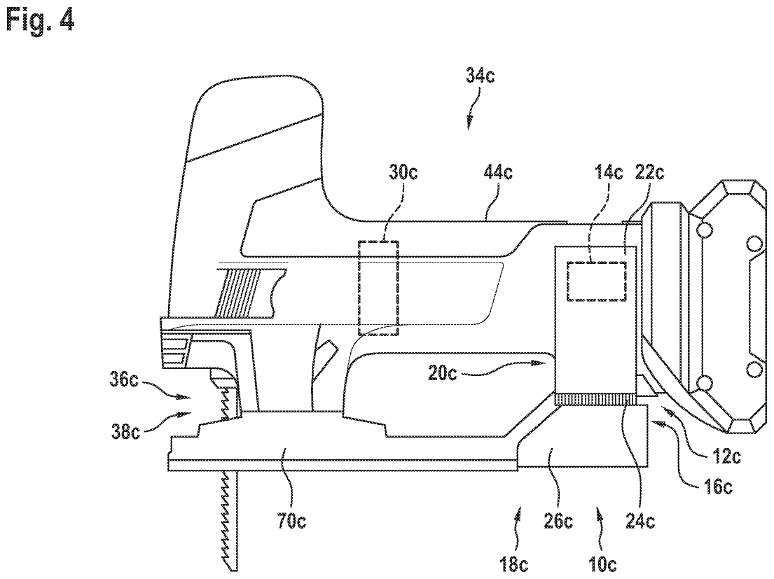

FIG. 4 shows a machine tool 34c. The machine tool 34c is designed as a hand-held machine tool. The machine tool 34c is designed as a jigsaw. Alternatively, it is also conceivable that the machine tool 34c is designed as a grinding machine, in particular as an orbital sander or as a rotary sander, as an oscillating saw, as a circular saw, as an angle grinder or as any other machine tool that appears to be useful to a person skilled in the art. Furthermore, it is alternatively conceivable that the machine tool 34c is designed as a household machine, in particular a kitchen machine or a cleaning machine, as a garden machine, for example a mowing machine, or the like.

The machine tool 34c has a machine tool apparatus 10c. The machine tool apparatus has at least one housing unit 12c. The housing unit 12c includes a cooling air inlet section 14c.

The machine tool apparatus 10c has at least one connecting unit 16c for fluidly connecting the cooling air inlet section 14c to a fluid unit 18c on the outside 20c of the housing unit 12c. The connection unit 16c includes a fluid channel element 22c for fluidly connecting the cooling air inlet section 14c to the fluid unit 18c.

The machine tool apparatus 10c has the fluid unit 18c. The fluid unit 18c has a filter element 24c. The fluid unit 18c includes a dust collection container 26c. The filter element 24c is disposed between the dust collection container 26c and the fluid channel element 22c. The machine tool 34c has a base plate 70c. The base plate 70c has an ablation guide element (not shown here). The fluid unit 18c is detachably, in particular non-destructively detachably, fastened to the base plate 70c. The fluid unit 18c is fluidly connected to the ablation guide element of the base plate 70c.

The machine tool 34c includes a machine tool housing 44c. The machine tool apparatus includes a fan unit 30c for generating an air flow between the fluid unit 18c and an interior of the housing unit 12c. The fan unit 30c is at least partially arranged in the housing unit 12c, in particular in the machine tool housing 44c.

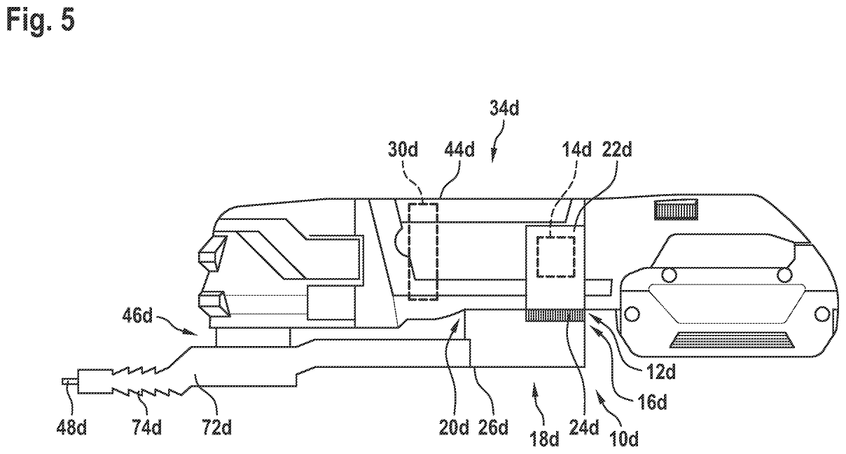

FIG. 5 shows a machine tool 34d. The machine tool 34d is designed as a hand-held machine tool. The machine tool 34d is designed as an oscillating saw. Alternatively, it is also conceivable that the machine tool 34d is designed as a grinding machine, in particular as an orbital sander or as a rotary sander, as a jigsaw, as a circular saw, as an angle grinder, or as any other machine tool that appears to be useful to a person skilled in the art. Furthermore, it is alternatively conceivable that the machine tool 34d is designed as a household machine, in particular a kitchen machine or a cleaning machine, as a garden machine, for example a mowing machine, or the like.

The machine tool 34d has a machine tool apparatus 10d. The machine tool apparatus 10d has at least one housing unit 12d. The housing unit 12d includes a cooling air inlet section 14d. The machine tool apparatus 10d includes at least one connection unit 16d for fluidly connecting the cooling air inlet section 14d to a fluid unit 18d on the outside 20d of the housing unit 12d. The connection unit 16d includes a fluid channel element 22d for fluidly connecting the cooling air inlet section 14d to the fluid unit 18d.

The machine tool apparatus 10d has the fluid unit 18d. The fluid unit 18d has a filter element 24d. The fluid unit 18d includes a dust collection container 26d. The filter element 24d is disposed between the dust collection container 26d and the fluid channel element 22d.

The machine tool 34d includes a machine tool housing 44d. The machine tool apparatus 10d includes a fan unit 30d for generating an air flow between the fluid unit 18d and an interior of the housing unit 12d. The fan unit 30d is at least partially arranged in the housing unit 12d, in particular in the machine tool housing 44d.

The machine tool 34d includes a tool holder 46d for receiving a tool 48d. The machine tool 34d has at least one extraction adapter 72d. The extraction adapter 72d includes an extraction snorkel 74d that at least partially surrounds the tool 48d. The extraction snorkel 74d is designed to be compressible in the axial direction. The extraction snorkel 74d is designed to follow movements, in particular oscillating movements, of the tool 48d. The extraction snorkel 74d is formed of an elastic material, for example. The extraction adapter 72d is detachably connected to the machine tool housing 44d. The extraction adapter 72d has an ablation guide element 76d, which is in particular at least partially formed by the extraction snorkel 74d. The ablation guide element 76d is fluidly connected to the fluid unit 18d.

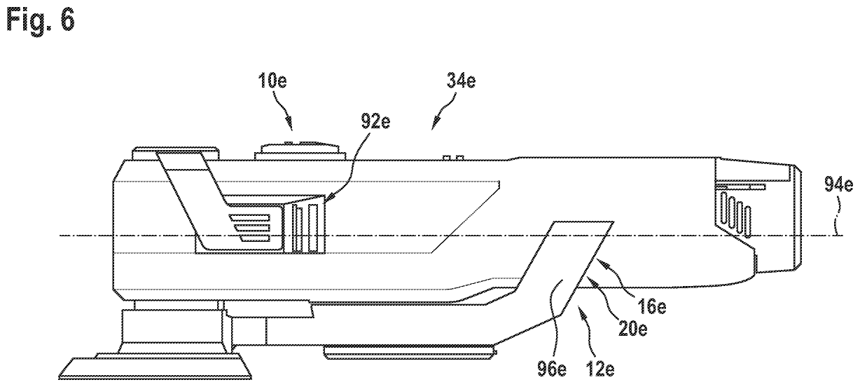

FIG. 6 shows a machine tool 34e with a machine tool apparatus 10e. As an example, the machine tool 34e is designed here as a multitool. Alternatively, however, it is also conceivable that the machine tool 34e is designed as another machine tool 34e that appears to be useful to a person skilled in the art.

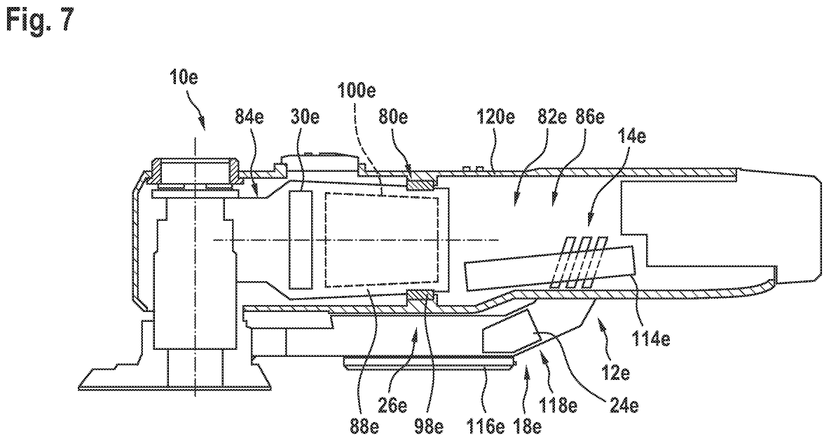

The machine tool apparatus 10e has a housing unit 12e. The housing unit 12e has a cooling air inlet section 14e (cf. FIG. 7). The cooling air inlet section 14e has several ventilation slots. The ventilation slots of the cooling air inlet section 14e are arranged on two sides of the housing unit 12e, in particular facing away from each other. Alternatively, however, it is also conceivable that the cooling air inlet section 14e, in particular its ventilation slots, is/are arranged only on one side of the housing unit 12e.

The housing unit 12e has at least one cooling air outlet section 92e. As an example, the cooling air outlet section 92e here has several ventilation slots. The ventilation slots of the cooling air outlet section 92e are arranged on two sides of the housing unit 12e, in particular sides facing away from each other. Alternatively, it is conceivable that the cooling air outlet section 92e, in particular its ventilation slots, is/are arranged on only one side of the housing unit 12e.

The cooling air outlet section 92e is arranged offset from the cooling air inlet section 14e when viewed in the direction of a main extension axis 94e of the housing unit 12e. The cooling air inlet section 14e is spaced apart from the cooling air inlet section 92e, as viewed in the direction of the main extension axis 94e of the housing unit 12e. An airflow guided from the cooling air inlet section 14e to the cooling air outlet section 92e of the housing unit 12e extends, at least in sections, at least substantially parallel to the main extension axis 94e of the housing unit 12e.

The machine tool apparatus 10e has a connection unit 16e for fluidly connecting the cooling air inlet section 14e to a fluid unit 18e on the outside 20e of the housing unit 12e. The connecting unit 16e is designed as pincer. The fluid unit 18e can be fastened to the housing unit 12e in a pincer-like manner. The connection unit 16e has two pincer elements 96e for fastening to the housing unit 12e. The pincer elements 96e are arranged on the fluid unit 18e. The pincer elements 96e are integrally designed with at least a portion of the fluid unit 18e.

In a condition of the fluid unit 18e fastened to the housing unit 12e, the pincer elements 96e are arranged on sides of the housing unit 12e facing away from each other, in particular, the pincer elements 96e abut the housing unit 12e on sides facing away from each other. The pincer elements 96e are disposed at the cooling air inlet section 14e in a state of the fluid unit 18e fastened to the housing unit 12e. The pincer elements 96e each include a fluid channel. The fluid channels of the pincer elements 96e fluidly connect the cooling air inlet section 14e, in particular its ventilation slots, with a dust collection container 26e of the fluid unit 18e.

Two connecting elements (not shown here) of the connecting unit 16e are arranged on the housing unit 12e, in particular on an outer wall of the housing unit 12e. The connecting elements are arranged on sides of the housing unit 12e facing away from each other. The connecting elements are provided to cooperate with the pincer elements 96e for fastening the fluid unit 18e to the housing unit 12e. As an example, the connecting elements are designed as latch recesses. Alternatively, however, it is also conceivable that the connecting elements are designed as latching projections or other connecting elements which appear to be useful to a person skilled in the art.

By elastically deflecting the pincer elements 96e relative to each other, particularly when mounting the fluid unit 18e to the housing unit 12e, a clamping force can be generated to fasten the fluid unit 18e to the housing unit 12e.

The machine tool apparatus 10e has a sealing unit 80e for dividing the interior 82e of the housing unit 12e into a positive pressure area 84e and a negative pressure area 86e.

The sealing unit 80e is provided to counteract undesired backflow of the airflow in the housing unit 12e. The sealing unit 80e is provided to reduce a maximum flow cross-sectional area relative to a maximum cross-sectional area of the housing unit 12e at a position of the sealing unit 80e. The cross-sectional area is at least substantially perpendicular to the main extension axis 94e of the housing unit 12e. The cross-sectional area of the housing unit 12e is bounded by an inner wall of the housing unit 12e.

The sealing unit 80e is arranged between a drive housing 88e of the machine tool apparatus 10e and the housing unit 12e, preferably the inner wall of the housing unit 12e. The sealing unit 80e seals a section between the housing unit 12e and the drive housing 88e, in particular at least with respect to the main extension axis 94e in the radial direction. The sealing unit 80e has a sealing element 98e. Alternatively, it is also conceivable that the sealing unit 80e comprises several sealing elements. In this example, the sealing element 98e is formed from an elastic material, in particular a rubber-elastic material. Alternatively, however, it is also conceivable that the sealing element 98e is designed from another material that would appear to be useful to a person skilled in the art. Alternatively or additionally, it is also conceivable that at least part of the sealing unit 80e is formed by the housing unit 12e.

The sealing element 98e is annular, preferably designed as a rubber ring. The sealing element 98e encloses the drive housing 88e at least substantially completely, preferably completely, in particular at least as viewed in the radial direction. The drive housing 88e is provided to receive a drive unit 100e of the machine tool 34e.

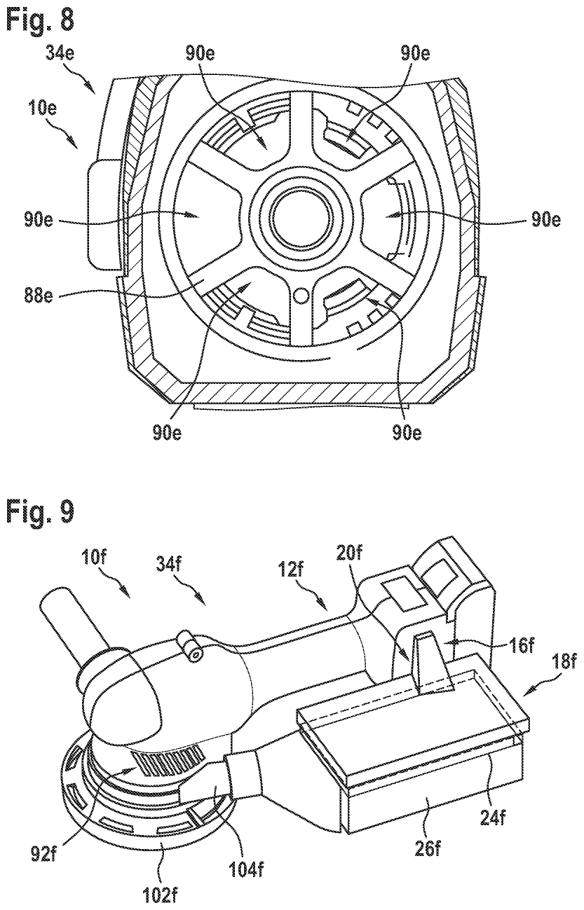

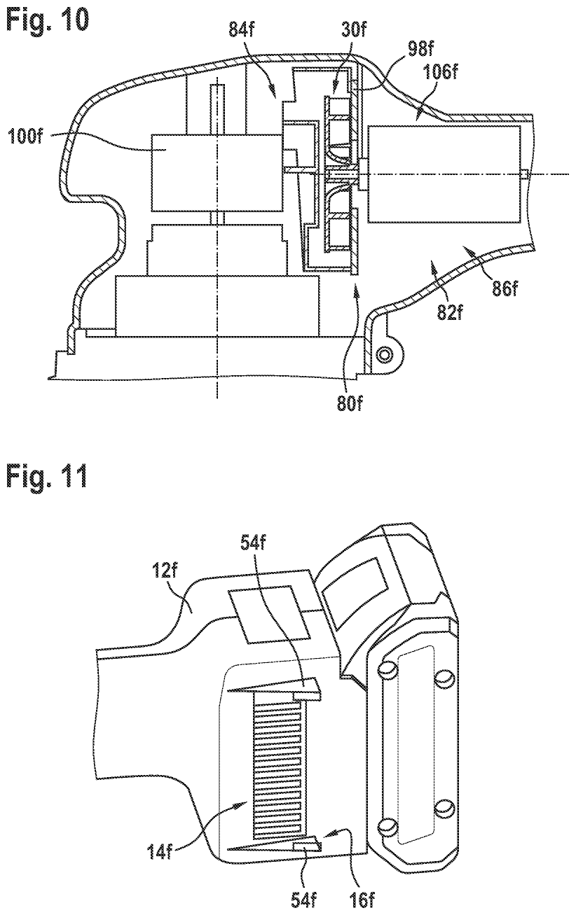

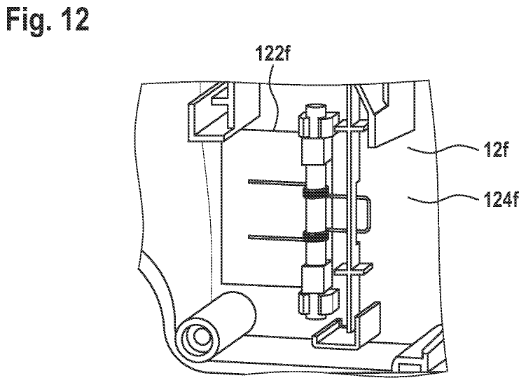

The drive housing 88e includes a plurality of ventilation ports 90e (see FIG. 8). The cross-section of the machine tool 34e shown in FIG. 8 is particularly perpendicular to the main extension axis 94e of the housing unit 12e. The positive pressure area 84e is connected to the negative pressure area 86e through the ventilation ports 90e. The sealing unit 80e is arranged in such a way that the air flow, in particular the entire air flow, running from the cooling air inlet section 14e to the cooling air outlet section 92e is guided through the ventilation ports 90e.

The machine tool apparatus 10e has a fan unit 30e. The fan unit 30e is designed to generate the air flow. The fan unit 30e is provided to cool the drive unit 100e and/or an electronics 114e of the machine tool 34e. In particular, the fan unit 30e is arranged on a side of the sealing unit 80e facing away from the cooling air inlet section 14e. In particular, the fan unit 30e is arranged on a side of the drive unit 100e facing away from the cooling air inlet section 14e.

In particular, the fan unit 30e generates a negative pressure in the negative pressure area 86e in at least one operating state. In particular, the fan unit 30e generates a positive pressure in the positive pressure area 84e in at least one operating condition.

The fluid unit 18e has a filter element 24e. The filter element 24e is arranged in a rear end section 118e of the fluid unit 18e, in particular of the dust collection container 26e, preferably with respect to a flow direction of the air flow.

The dust collection container 26e includes a closure element 116e. The closure element 116e is provided to provide a dust-tight closure of the dust collection container 26e. The dust collection container 26e can be emptied by opening the closure element 116e. As an example, the closure element 116e is designed here as a closure cap.

A major portion of the fluid unit 18e is disposed below the housing unit 12e, in particular a main handle 120e of the housing unit 12e, in a state disposed on the housing unit 12e, in particular with respect to a substrate extending parallel to the main extension axis 94e.

FIG. 9 shows a machine tool 34f with a machine tool apparatus 10f. As an example, the machine tool 34f is designed here as a grinding machine, in particular as a rotary sander. Alternatively, however, it is also conceivable that the machine tool 34f is designed as another machine tool 34f that appears to be useful to a person skilled in the art.

The machine tool apparatus 10f has a housing unit 12f. The machine tool apparatus 10f has a fluid unit 18f. The fluid unit 18f is detachably fastened to the housing unit 12f. The machine tool apparatus 10f includes a fan unit 30f for generating an air flow between the fluid unit 18f and an interior of the housing unit 12f.

The machine tool 34f includes a grinding pad 102f. The abrasive pad 102f has holes through which dust, in particular, can be extracted from a processing point of a workpiece. The dust can be extracted into the fluid unit 18f via an ejection port 104f of the machine tool 34f, in particular by means of negative pressure. The fluid unit 18f is fitted, preferably in an airtight manner, onto the extraction port 104f.

The fluid unit 18f includes a filter element 24f. As an example, the filter element 24f is designed here as a pleated filter. A longitudinal extension of pleats of the pleated filter preferably extend at least substantially parallel to a main extension axis of the extraction port 104f, in particular to a flow direction of the air flow in the fluid unit 18f, preferably at least in the area of the filter element 24f. In particular, the pleats of the filter element 24f are arranged such that in at least one operating condition the pleats are flowed against longitudinally by the airflow.

The extraction port 104f may be arranged tangential to the direction of rotation of the abrasive pad 102f. However, it is alternatively conceivable that the extraction port 104f is arranged in an orientation with respect to the abrasive pad 102f that is different from a tangential orientation with respect to the abrasive pad 102f.

The housing unit 12f has a cooling air inlet section 14f (cf. FIG. 11). The machine tool apparatus 10f has at least one connection unit 16f for fluidly connecting the cooling air inlet section 14f to the fluid unit 18f on the outside 20f of the housing unit 12f. The connecting unit 16f has two connecting elements 54f. As an example, the connecting elements 54f are designed here as latching elements, in particular latching hooks. By means of the connection unit 16f, a dust-tight connection can be made between the fluid unit 18f and the cooling air inlet section 14f.

The housing unit 12f includes a cooling air outlet section 92f. In particular, the air flow that can be generated by means of the fan unit 30f runs from the grinding pad 102f via the fluid unit 18f through the cooling air inlet section 14f via electronics (not shown here) of the machine tool 34f via a drive unit 100f of the machine tool 34f to the cooling air outlet section 92f. The drive unit 100f is provided for driving the abrasive pad 102f.

The fan unit 30f includes a drive unit 106f. The drive unit 106f is designed separately from the drive unit 100f. The fan unit 30f has at least one fan element. As an example, the fan element is designed here as a radial fan. Alternatively, it is conceivable that the fan element is designed as an axial fan. The drive unit 106f is provided for driving the fan element. The fan unit in particular the drive unit 106f, can be operated independently of the drive unit 100f. In particular, the fan unit 30f is operable independently of the drive unit 100f. The drive unit 100f is free of a fan unit, in particular separate from the fan unit 30f. For example, the fan unit 30f is operable in an idle mode, particularly when dust extraction is not required.

The fan unit 30f is capable of generating the airflow along and/or through the drive unit 106f. The fan unit 30f is provided for cooling the drive unit 100f and, in particular, for cooling the drive unit 106f.

The machine tool apparatus 10f has a sealing unit 80f. The sealing unit 80f has a

sealing element 98f. As an example, the sealing element 98f is designed here as an air baffle.

The fan unit 30f has an air guide housing for guiding the air flow. The air guide housing 110f and/or the sealing unit 80f divide the interior space 82f into a positive pressure area 84f and a negative pressure area 86f.

The machine tool 34f, in particular the machine tool apparatus 10f, has a user interface. It is conceivable that the user interface is configured to indicate a fill level of the dust collection container 26f. For example, the filling state can be determined via a voltage recording of the fan unit 30f, in particular by means of a control unit.

The housing unit 12f includes an air bypass 122f. The air bypass 122f is disposed on an outer wall 124f of the housing unit 12f. As an example, the air bypass 122f is designed here as a spring-prestressed bypass flap. In this example, the bypass flap is arranged spring-prestressed on the outer wall 124f by means of a torsion spring of the air bypass 122f. The bypass flap is rotatably arranged on the outer wall 124f. The air bypass 122f is provided to open when a negative pressure inside the housing unit 12f exceeds a limit.

1. A machine tool apparatus comprising:
at least one housing unit which has a cooling air inlet section and a cooling air outlet section, the cooling air outlet section being offset relative to the cooling air inlet section along a direction of a main extension axis of the housing unit;
a connection unit configured to fluidly connect the cooling air inlet section to a fluid unit arranged on an outside of the at least one housing unit.

2. The machine tool apparatus according to claim 1, wherein the connection unit comprises at least one fluid channel element configured to fluidly connect the cooling air inlet section to the fluid unit, the at least one fluid channel element configured to be detachably fastened to the outside of the at least one housing unit.

3. The machine tool apparatus according to claim 1, further comprising:
the fluid unit, which comprises at least one filter element.

4. The machine tool apparatus according to claim 3, wherein the fluid unit further comprises at least one dust collection container.

5. The machine tool apparatus according to claim 4, wherein the dust collection container has a fluid outlet section, which is connected to the cooling air inlet section of the housing unit.

6. The machine tool apparatus according to claim 1, wherein the fluid unit is designed as an extraction unit configured for extracting an ablation generated when machining a workpiece, the fluid unit being free of a fan element.

7. The machine tool apparatus according to claim 3, further comprising:
a fan unit configured to generate an air flow between the fluid unit and an interior of the at least one housing unit.

8. The machine tool apparatus according to claim 7, wherein the fan unit draws air into the fluid unit in at least one operating condition.

9. The machine tool apparatus according to claim 7, wherein the fan unit is arranged at least partially in the at least one housing unit.

10. The machine tool apparatus according to claim 7, further comprising:
a further fan unit configured to generate the air flow, the further fan unit arranged on the at least one housing unit.

11. The machine tool apparatus according to claim 1, wherein the connecting unit is configured as pincer.

12. The machine tool apparatus according to claim 1, further comprising:
a sealing unit that divides an interior space of the housing unit into a positive pressure area and a negative pressure area.

13. The machine tool apparatus according to claim 12, further comprising:
a drive housing having at least one ventilation port through which the positive pressure area is connected to the negative pressure area.

14. The machine tool apparatus according to claim 4, further comprising:
a fan unit configured to generate an air flow between the fluid unit and an interior of the at least one housing unit,
wherein:
the machine tool apparatus is configured such that the air flow is directed from a tool holder section through the dust collecting container, the filter element, the connecting unit, and the cooling air inlet section, and is then guided through electronics, a drive unit that is configured to drive a tool, and the fan unit to the cooling air outlet section.

15. A machine tool comprising the machine tool apparatus according to claim 1.

16. A method for operating a machine tool having a machine tool apparatus that includes at least one housing unit which has a cooling air inlet section and a cooling air outlet section, the cooling air outlet section being offset relative to the cooling air inlet section along a direction of a main extension axis of the housing unit; and a connection unit configured to fluidly connect the cooling air inlet section to a fluid unit arranged on an outside of the at least one housing unit, the method comprising:
extracting air out of a tool holder section of the machine tool; and
blowing the air out into a near area of the tool holder section.
